(19) United States
(12) Patent Application Publication
(10) Pub. No.: US 2016/0280054 A1
(43) Pub. Date: Sep. 29, 2016

(54) GLASS RUN

(71) Applicant: TOYODA GOSEI CO., LTD., Kiyosu-shi (JP)

(72) Inventors: Kentaro ADACHI, Kiyosu-shi (JP); Mitsunobu TERAMOTO, Kiyosu-shi (JP); Masahiro TAKAYA, Kiyosu-shi (JP); Yuhei KOBAYASHI, Kiyosu-shi (JP)

(21) Appl. No.: 15/055,820

(22) Filed: Feb. 29, 2016

(30) Foreign Application Priority Data
Mar. 27, 2015 (JP) 2015-065616

(51) Int. Cl. B60J 10/76; B60J 10/20; B60J 10/84; E06B 7/22

(52) U.S. Cl. CPC B60J 10/76; E06B 7/22; B60J 10/20; B60J 10/84

(57) ABSTRACT

A glass run for use in a sashless door-type automobile, which is capable of exhibiting excellent sealing property and being readily produced without generating any crack in connection faces. The glass run includes an upper side portion, a vertical side portion and a corner portion. In the upper side portion, a glass run section and a trim section are integrally formed. The trim section has a side wall on the side of the glass run section, a side wall on the side of an automobile body, and a bottom wall with a generally U-shaped cross-section. The corner portion includes an upper side connection part and a vertical side connection part. Connection faces between the upper side connection part of the corner portion and the upper side portion are inclined to a longitudinal direction of the upper side portion.

### CROSS-REFERENCE TO RELATED APPLICATION

This application is related to and claims priority from Japanese patent Application No. 2015-065616 incorporated herein by reference.

### BACKGROUND OF THE INVENTION

1. Field of the Invention

The present invention relates to a glass run adapted to be attached to a door frame of an automobile for providing a seal between a door opening portion and an automobile door.

2. Description of Related Art

In one example of conventional sealing structures for providing a seal between a door opening portion and an automobile door having a door sash, an opening trim weather strip is attached to a flange provided in the door opening portion, and a door weather strip is attached to an outer periphery of the door sash. When the automobile door is closed, a tubular seal portion of the opening trim weather strip contacts a protrusion of the door sash, and a tubular seal portion and a seal lip of the door weather strip contact an outer panel of the door opening portion to seal a gap between the door opening portion and the automobile door.

And a door glass raised and lowered inside the automobile door is held with a glass run of which an outer periphery thereof is attached along an inner periphery of the door sash, and is raised and lowered in a groove of the glass run, which has a generally U-shaped cross-section. This glass run provides a seal between the door glass and the door sash.

In side surfaces of the automobile, the glass runs, the door sashes and center pillars are exposed and outstanding around the door glasses so that it has been required to improve the design thereof. In addition, the glass runs exist between the door sashes and the door glasses, and between the center pillars and the door glasses so as to define gaps between the door sashes and the door glasses, which are less preferable in design.

In order to overcome the above-described problem, as shown in FIG. 1, in a sashless door-type automobile body, an exterior surface of a door sash is removed except for a flange so as to freely raise and lower a door glass 10 above the door belt line of an automobile door 12. With this arrangement, in the side surface of the automobile, only the door glass 10 is visible above the door belt line of the automobile door 12.

In this case, as shown in FIG. 2, a glass run 14 includes a glass run section 16 adapted to provide a seal between the door glass 10 and a door frame 18, and a trim section 20 adapted to attach the glass run 14 to a flange 22 extending along an end edge of the door frame 18 (see Japanese patent application laid-open No. 2002-46476, for example.). The glass run section 16 has a main body with a generally U-shaped cross-section, which includes an outer side wall 24, an inner side wall 26 and a bottom wall 28. An outer seal lip 30 and an inner seal lip 32 respectively extend from ends of the outer side wall 24 and the inner side wall 26 obliquely in an interior space of the main body. The outer seal lip 30 and the inner seal lip 32 provide seals against the door glass 10.

The trim section 20 has a generally U-shaped cross-section, and includes a side wall 34 formed integrally with the bottom wall 28 of the glass run section 16, a side wall 36 formed on the side of an automobile body, and a bottom wall 38. An outer seal lip 40 and an inner seal lip 42 are formed in an exterior surface of the side wall 36 for contacting and sealing a door opening portion 44 when the automobile door 12 is closed.

And, in corner parts of the door frame 18, an upper side portion of the glass run 14, which is formed by extrusion, and a vertical side portion of the glass run 14, which is formed by extrusion, are connected to each other via a glass run formed by molding.

Where the glass runs 14 thus arranged are handled during the production steps thereof, and where the glass runs 14 are curved during the attaching step to the door panel, loads may be applied to connection faces between the extruded parts and the molded parts to cause generation of cracks.

In this case, as shown in FIG. 3, beads 45 have been provided around connection faces 46 in a corner portion 48 for connecting an upper side portion 50 and a vertical side portion 52 to reinforce the connection faces 46 (see Japanese patent application laid-open No. 2001-301542, for example.). However, design characteristics in design surfaces and sealing properties in sealing surfaces are degraded so that such beads cannot be provided in such design surfaces and sealing surfaces.

### SUMMARY OF THE INVENTION

It is an object of the present invention to provide a glass run for use in a sashless door-type automobile, which can exhibit excellent sealing properties, and can be readily produced without generating any crack in connection faces.

In order to achieve the above-described object, according to a first aspect of the present invention, in a glass run adapted to be attached to a door frame of an automobile door for providing a seal between a door opening portion and the automobile door, the glass run has an upper side portion formed by extrusion and adapted to be attached to an upper side of the door frame, a vertical side portion formed by extrusion and adapted to be attached to a vertical side of the door frame, and a corner portion formed by molding to connect the upper side portion and the vertical side portion to each other, and adapted to be attached to a corner of the door frame.

The upper side portion includes a glass run section adapted to seal a door glass, and a trim section adapted to be attached to the door frame such that the glass run section and the trim section are integrally formed with each other. The glass run section includes an outer side wall, an inner side wall and a bottom wall with a generally U-shaped cross-section, and an outer seal lip and an inner seal lip respectively extend from ends of the outer side wall and the inner side wall obliquely in an interior space of the glass run section with a generally U-shaped cross-section. The trim section includes one side wall located on the side of the glass run section, the other side wall located on the side of an automobile body, and a bottom wall to define a generally U-shaped cross-section.

The corner portion includes a glass run section and a trim section, which are integrally formed with each other, and includes an upper side connection part adapted to be connected to the upper side portion, and a vertical side connection part adapted to be connected to the vertical side portion.

And connection faces between the upper side connection part of the corner portion and the upper side portion are inclined to a longitudinal direction of the upper side portion of the glass run. With the arrangement of the first aspect of the present invention, the upper side portion includes a glass run section adapted to seal a door glass, and a trim section adapted to be attached to the door frame such that the glass run section and the trim section are integrally formed with each other. Therefore, the glass run section and the trim section can be formed by extrusion at the same time to facilitate the production of the upper side portion. In addition, the total dimensions of the glass run section and the trim section can be decreased to make the upper side of the door clear, thus improving the appearance therearound.

The glass run section includes an outer side wall, an inner side wall and a bottom wall with a generally U-shaped cross-section, and an outer seal lip and an inner seal lip respectively extend from ends of the outer side wall and the inner side wall obliquely in an interior space of the glass run section with a generally U-shaped cross-section. As a result, the raising and lowering of the door glass can be guided by the glass run section, and the door glass can be held with the outer seal lip and the inner seal lip to provide a seal around an outer periphery of the door glass.

The trim section includes one side wall located on the side of the glass run section, the other side wall located on the side of an automobile body, and a bottom wall to define a generally U-shaped cross-section. As a result, the glass run can be attached while holding an end of the door frame with the side walls and the bottom wall of the trim section, whereby when the door glass is raised or lowered, the glass run section can securely seal the door glass.

The corner portion includes a glass run section and a trim section, which are integrally formed with each other, and includes an upper side connection part adapted to be connected to the upper side portion, and a vertical side connection part adapted to be connected to the vertical side portion. In the upper side connection part, a corner trim seal lip for contacting the door opening portion of the automobile body is formed in the trim section thereof. As a result, the glass run sections and the trim sections of the upper side portion and the vertical side portion can be bonded to each other by vulcanization by means of the glass run section and the trim section of the corner portion. The corner trim seal lip can provide a seal between the door opening portion and the door frame in the corner portion.

Connection faces between the upper side connection part of the corner portion and the upper side portion are inclined to the longitudinal direction of the upper side portion of the glass run. As a result, the area of the connection faces increases to make the connection strength great, and stresses to be applied to the connection faces are divided in the peeling-off direction and the shearing direction of the glass run, whereby the peeling in the connection faces can be restrained.

According to a second aspect of the present invention, the side wall of the upper side portion, which is located on the side of an automobile body, has an upper trim seal lip contacting the door opening portion, the upper side connection part of the corner portion has a corner trim seal lip in the trim section thereof, which contacts the door opening portion, and the connection face between the upper trim seal lip and the corner trim seal lip is inclined to a longitudinal direction of the upper side portion of the glass run.

With the arrangement of the second aspect of the present invention, the side wall of the upper side portion, which is located on the side of an automobile body, has an upper trim seal lip contacting the door opening portion. As a result, when the automobile door is closed, the upper trim seal lip contacts the door opening portion to provide a seal between the automobile door and the door opening portion. The upper side connection part of the corner portion has a corner trim seal lip in the trim section for contacting the door opening portion. As a result, when the automobile door is closed, the corner trim seal lip contacts the door opening portion to provide a seal between the corner portion of the automobile door and a corner of the door opening portion. The connection face between the upper trim seal lip and the corner trim seal lip is inclined to the longitudinal direction of the upper side portion of the glass run. As a result, the area of the connection face between the upper trim seal lip and the corner trim seal lip increases to make the connection strength great, and stresses to be applied to the connection face are divided in the peeling-off direction and the shearing direction of the glass run, whereby the peeling in the connection face can be restrained.

According to a third aspect of the present invention, the upper trim seal lip has rigidity greater than that of the corner trim seal lip.

With the arrangement of the third aspect of the present invention, the upper trim seal lip has rigidity greater than that of the corner trim seal lip so that the corner portion can be readily molded. In addition, where the rigidity differs with respect to the connection face between the upper trim seal lip and the corner trim seal lip, it is inclined to the longitudinal direction of the upper side portion so that the area of the connection face can be increased to make the connection strength great, whereby the peeling in the connection face can be restrained.

According to a fourth aspect of the present invention, the connection face between the upper trim seal lip and the corner trim seal lip is inclined such that a root of the upper trim seal lip thrusts on the side of the corner trim seal lip, as compared with a tip end of the upper trim seal lip. With the arrangement of the fourth aspect of the present invention, the connection face between the upper trim seal lip and the corner trim seal lip is inclined such that a root of the upper trim seal lip thrusts on the side of the corner trim seal lip, as compared with a tip end of the upper trim seal lip. As a result, when the corner portion is molded, a longitudinal tip end of the upper side portion of the glass run is held with a mold, whereas a transverse tip end of the upper trim seal lip is held while gradually changing from the root thereof so as to be connected without generating any deformation in the upper trim seal lip regardless of the flowing of a molding material.

According to a fifth aspect of the present invention, a low friction sliding layer is formed on a face of the upper trim seal lip, which contacts the door opening portion.

With the arrangement of the fifth aspect of the present invention, the low friction sliding layer is formed on the face of the upper trim seal lip, which contacts the door opening portion, so that generation of abnormal noises is restrained when the door is opened and closed. According to a sixth aspect of the present invention, an upper connection face of the corner portion between the outer side wall of the glass run section and the bottom wall of the trim section of the upper side portion, and the outer side wall of the glass run section and the bottom wall of the trim section of the corner portion are inclined to a longitudinal direction of the upper side portion of the glass run.

With the arrangement of the sixth aspect of the present invention, the upper connection face of the corner portion between the outer side wall of the glass run section and the bottom wall of the trim section of the upper side portion, and the outer side wall of the glass run section and the bottom wall of the trim section of the corner portion are inclined to a longitudinal direction of the upper side portion. As a result, the area of the connection face between the outer side wall of the glass run section and the bottom wall of the trim section of the upper side portion, and the outer side wall of the glass run section and the bottom wall of the trim section of the corner portion increases to make the connection strength great, and stresses to be applied to the connection face are divided in the peeling-off direction and the shearing direction of the glass run, whereby the peeling in the bottom wall of the trim section of the upper side portion and the bottom wall of the trim section of the upper side connection part of the corner portion can be restrained in the connection face therebetween.

According to a seventh aspect of the present invention, a connection face between the upper trim seal lip and the corner trim seal lip, and a connection face between the bottom wall of the trim section of the upper side portion and the bottom wall of the trim section of the upper side connection part of the corner portion are respectively inclined with an inclination angle of 15 through 45 degrees.

With the arrangement of the seventh aspect of the present invention, the connection face between the upper trim seal lip and the corner trim seal lip, and the connection face between the bottom wall of the trim section of the upper side portion and the bottom wall of the trim section of the upper side connection part of the corner portion are respectively inclined with an inclination angle of 15 through 45 degrees, whereby the area of the connection faces can be sufficiently increased to make the connection strength great, and stresses to be applied to the connection faces are divided in the peeling-off direction and the shearing direction of the glass run so that the peeling in the connection faces can be restrained.

When the inclination angle exceeds 45 degrees, the connection faces are inclined to the longitudinal direction to excessively spread, whereby the molding of the glass run requires much labor and time, whereas when the inclination angle is less than 15 degrees, the area of the connection faces decreases so that the connection strength thereof becomes insufficient.

According to an eighth aspect of the present invention, the side wall of the trim section, which is located on the side of the glass run section, and the bottom wall of the glass run section are formed integrally with each other.

With the arrangement of the eighth aspect of the present invention, the side wall of the trim section, which is located on the side of the glass run section, and the bottom wall of the glass run section are formed integrally with each other so that the entire wall thickness of the side wall of the trim section and the bottom wall of the glass run section can be decreased, whereby the weight of the glass run can be reduced. In addition, the dimensions of the glass run can be reduced.

According to a ninth aspect of the present invention, a decoration member is formed on exterior surfaces of the bottom wall of the trim section and the outer side wall of the glass run section continuously with the upper side portion.

With the arrangement of the ninth aspect of the present invention, the decoration member is formed on exterior surfaces of the bottom wall of the trim section and the outer side wall of the glass run section continuously with the upper side portion so that the appearance around the upper side portion of the door frame.

Connection faces between the upper side connection part of the corner portion and the upper side portion are inclined to the longitudinal direction of the glass run. As a result, the area of the connection faces increases to make the connection strength great, and stresses to be applied to the connection faces are divided in the peeling-off direction and the shearing direction of the glass run, whereby the peeling in the connection faces can be restrained.

Other objects, features, and characteristics of the present invention will become apparent upon the consideration of the following description and the appended claims with reference to the accompanying drawings, all of which form a part of this specification.

### BRIEF DESCRIPTION OF THE DRAWINGS

FIG. 1 is a side view of an automobile;

FIG. 2 is a cross-sectional view of a conventional glass run;

FIG. 3 is a perspective view of a corner portion of another conventional glass run;

FIG. 4 is a cross-sectional view of an upper side portion in one embodiment of a glass run in accordance with the present invention, which is taken along line A-A of FIG. 1;

FIG. 5 is a front view of a corner portion in one embodiment of a glass run in accordance with the present invention;

FIG. 6 is a rear view of a corner portion in one embodiment of a glass run in accordance with the present invention;

FIG. 7 is a plan view of a connection part for connecting an upper side portion to a corner portion of a glass run in one embodiment of the present invention; and

FIG. 8 is a front view of a glass run in one embodiment of the present invention.

### DETAILED DESCRIPTION OF THE PREFERRED EMBODIMENTS

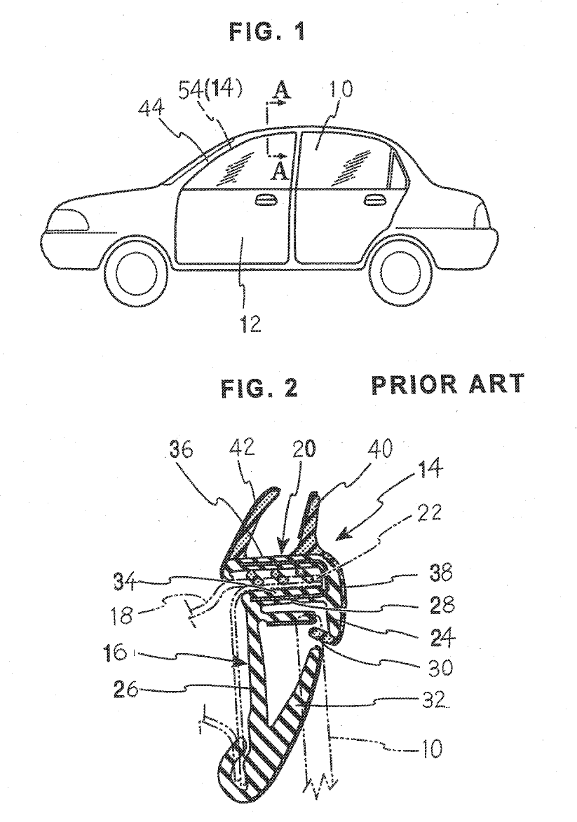

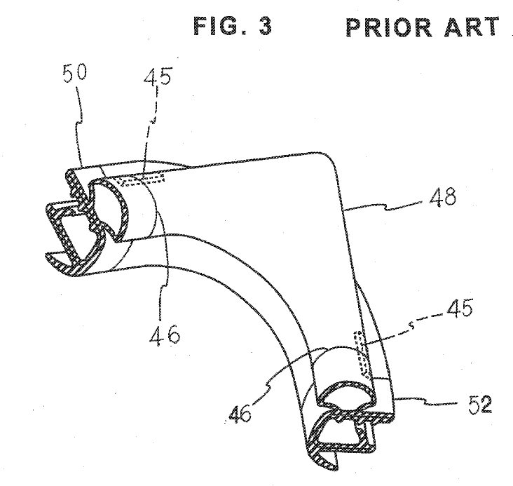

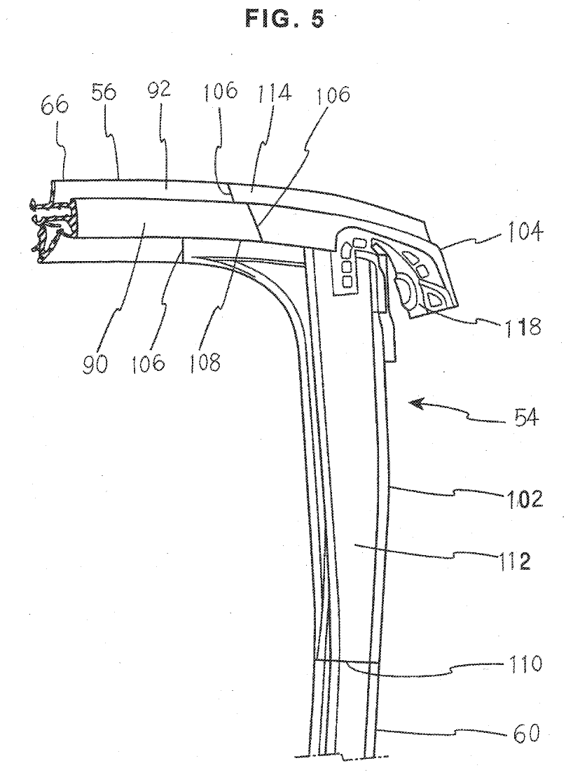

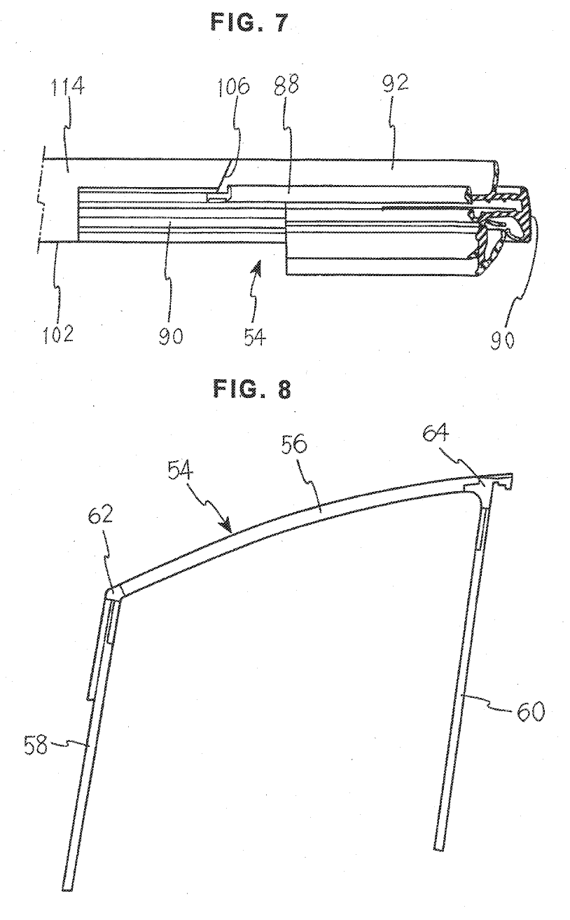

One embodiment of the present invention will be explained with reference to FIG. 1, and FIG. 5 through FIG. 8.

FIG. 1 and FIGS. 5 through 8 show one embodiment of the present invention. FIG. 1 is a side view of an automobile. As shown in FIG. 1, a glass run 54 in accordance with the present invention is used in a sashless door-type automobile. An exterior part of the door sash is removed above the door belt line of a front door and a rear door as the door 12 of the automobile, and only door glasses 10 are visible in an exterior side of the automobile over an entire surface thereof. The door glasses 10 can slide upwardly and downwardly of the front door and the rear door of the automobile.

As shown in FIG. 8, the glass run 54 includes an upper side portion 56 for attachment to an upper side of a door frame 18, a front vertical side portion 58 for attachment to a front vertical side of the door frame 18, a rear vertical side portion 60 for attachment to a rear vertical side of the door frame 18, a front corner portion 62 adapted to connect the upper side portion 56 to the front vertical side portion 58 for attachment to a front corner of the door fame 18, and a rear corner portion 64 adapted to connect the upper side portion 56 to the rear vertical side portion 60 for attachment to a rear corner of the door fame 18. With this arrangement, not only the upper side of the door frame 18 but also vertical sides of the door frame 18, which extend along side edges of the door glass 10, are held and sealed with the glass run 54. In addition, the corners of the door frame 18 can be securely sealed with the front corner portion 62 and the rear corner portion 64.

The upper side portion 56, the front vertical side portion 58 and the rear vertical side portion 60 are respectively formed by extrusion, and are respectively cut to a predetermined length. The front corner portion 62 and the rear corner portion 64 are formed by molding. Upon molding, the front corner portion 62 connects the upper side portion 56 to the front vertical side portion 58 by vulcanized adhesion upon molding, whereas the rear corner portion 64 connects the upper side portion 56 to the rear vertical side portion 60 by vulcanized adhesion upon molding.

The present invention relates to the glass run 54 for attachment to the door frame 18, and more particularly, to a part of a corner portion on the side of the upper side portion 56. The present invention will be explained with reference to the rear corner portion 64 of a front door, and particularly, to the part of the rear corner portion 64 on the side of the upper side portion 56, but can be also applied to the front corner portion 62 of a rear door.

First, the configuration of the upper side portion 56 will be explained, and next, the configurations of the rear corner portion 64 along with a notched part of the upper side portion 56 used therefor will be explained.

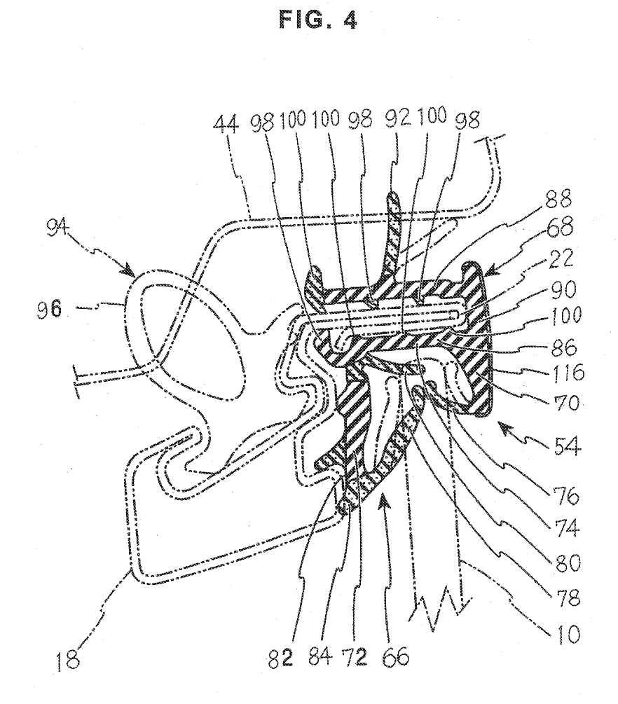

As shown in FIG. 4, the upper side portion 56 of the glass run 54 includes a glass run section 66 for attachment along an inner periphery of the door frame 18 and a trim section 68 for attachment to the flange 22 that is provided along an end of the door frame 18. First, configurations of the glass run section 66 and the trim section 68 will be respectively explained.

The glass run section 66 has a main body with a generally U-shaped cross-section, which includes an outer side wall 70, an inner side wall 72 and a bottom wall 74. An outer seal lip 76 and an inner seal lip 78 respectively extend from ends of the outer side wall 70 and the inner side wall 72 obliquely in an interior space of the main body. Therefore, an end edge of the door glass 10 slides in the interior space of the main body of the glass run section 66, which includes the outer side wall 70, the inner side wall 72 and the bottom wall 74, thereby holding and sealing the door glass 10.

The outer seal lip 76 and the inner seal lip 78 of the glass run section 66 are composed of a soft material. It is preferable to use a thermoplastic olefin elastomer as the soft material. Since the soft material is used, the outer seal lip 74 and the inner seal lip 78 can flexibly bend. When the door glass 10 is raised, they can securely contact the end edge of the door glass 10 to provide a seal between the door glass 10 and the door frame 18.

In the case where the thermoplastic olefin elastomer is used, and an olefin synthetic resin is used as the trim section 68, they are readily formed integrally, and recycling of the glass run is facilitated. Alternatively, fine porous foamed bodies can be used.

It is preferable to increase the dimensions and the wall thickness of the inner side wall 72 and the inner seal lip 78, as compared with those of the outer side wall 70 and the outer seal lip 76. In this case, when the door glass 10 is raised and inserted in the interior space of the glass run 54, the door glass 10 can be shifted outwardly to reduce level difference in the exterior surface of the door 12, thereby improving the appearance therearound, and restraining the generation of wind noises.

It is preferable to apply a low friction sliding member to surfaces of the outer seal lip 76 and the inner seal lip 78, which are adapted to contact the door glass 10. Examples of the low friction sliding member include TPV (dynamic crosslinking type olefin thermoplastic elastomer) exhibiting low sliding properties, which is formed into a thin film thereon, or silicon paints, urethane paints, etc. are painted thereon. With this arrangement, the door glass can be raised and lowered smoothly, and generation of abnormal noises can be prevented.

A bottom lip 80 can be formed on an interior side of the bottom wall 74 so as to project from a joint between the inner side wall 72 and the bottom wall 74. When the door glass 10 is raised, the bottom lip 80 contacts an upper end edge of the door glass 10 to absorb shocks against the bottom wall 74. It is preferable to apply a low friction sliding member to a surface of the bottom lip 80, too.

An attaching recess 82 is provided in an exterior surface of a tip end of the inner side wall 72. When the glass run 54 is attached to the door frame 18, a protrusion provided in the door frame 18 is engaged with the attaching recess 82 to hold the inner side wall 72 of the glass run section 66.

An inner cover lip 84 is formed along the end of the inner side wall 72 so as to extend outwardly of the interior space of the main body of the glass run section 66 and contact the protrusion of the door frame 18.

Next, the trim section 68 will be explained. As shown in FIG. 4, the trim section 68 has a generally U-shaped cross-section, and includes a side wall 86 adapted to be joined to the bottom wall 74, a side wall 88 for facing the door opening portion 44, and a bottom wall 90. The flange 22 of the door frame 18 is inserted into an interior space of the trim section 68, and held therein, whereby the glass run 54 is attached to the door frame 18.

An upper trim seal lip 92 projects from an exterior surface of the side wall 88 of the trim section 68, which faces the door opening portion 44. When the door 12 is closed, the upper trim seal lip 92 contacts the door opening portion 44 to provide a seal between the door opening portion 44 and the door frame 18. Two upper trim seal lips 92 can be provided, and in this case, a double seal is provided between the door opening portion 44 and the door frame 18.

As shown in FIG. 4, a door weather strip 94 having a tubular seal portion 96 for contacting the door opening portion 44 is attached to the door frame 18 inwardly of the glass run 54. The upper trim seal lip 92 of the glass run 54 and the tubular seal portion 96 of the door weather strip 94 can provide a double seal against the door opening portion 44.

A plurality of holding lips 98 are formed in an interior surface of the side wall 88 of the trim section 80, whereas a plurality of holding ridges 100 are formed in an interior surface of the side wall 86 of the trim section 68. As shown in FIG. 4, when the flange 22 of the door frame 18 is inserted into the interior space of the trim section 68, one side surface of the flange 22 can be held with the holding lips 98, whereas the other side surface of the flange 22 can be held with the holding ridges 100.

The trim section 68 is arranged such that the side wall 86 on the side of the glass run section 66, the side wall 88 for facing the door opening portion 44, the bottom wall 90, and the holding ridges 100 are composed of a hard material, whereas the upper trim seal lip 92 and the holding lips 98 are composed of a soft material. The trim section 68 is formed simultaneously with the glass run section 66 by extruding the hard material and the soft material.

As a result, the main body of the trim section 68 exhibits high rigidity so as to hold the flange 22 securely. The upper trim seal lip 92 flexibly bends to conform to the configuration of the door opening portion 44, and contacts the same to provide a seal thereagainst. And the holding lips 98 flexibly contact the flange 22 to provide a seal thereagainst.

The front vertical side portion 58 and the rear vertical side portion 60 are respectively configured to have a main body with a generally U-shaped cross-section, which includes an outer side wall 70, an inner side wall 72 and a bottom wall 74, similarly to the glass run section 66 of the upper side portion 56. An outer seal lip 76 and an inner seal lip 78 respectively extend from ends of the outer side wall 70 and the inner side wall 72 obliquely in an interior space of the main body. Therefore, an end edge of the door glass 10 slides in the interior space of the main body of the glass run section 66, which includes the outer side wall 70, the inner side wall 72 and the bottom wall 74, thereby holding and sealing the door glass 10.

The outer seal lip 76 and the inner seal lip 78 can respectively have a sub-seal lip in an interior of the main body having a generally U-shaped cross-section on the side of the bottom wall 74.

Next, the rear corner portion 64 will be explained with reference to FIG. 5 through FIG. 7.

The rear corner portion 64 includes a corner connection section 102 adapted to connect the upper side portion 56 to the rear vertical side portion 60, and a corner engagement section 104 adapted to extend from the corner connection section 102 rearwardly for engagement with a rear end of the door frame 18. Therefore, upon molding the rear corner portion 64, the upper side portion 56 and the rear vertical side portion 60 are simultaneously bonded to each other through vulcanization with the corner connection section 102. In addition, the corner engagement section 104 can attach the rear corner portion 64 to the rear end of the door frame 18, thereby preventing the rear corner portion 64 from coming off the door frame 18.

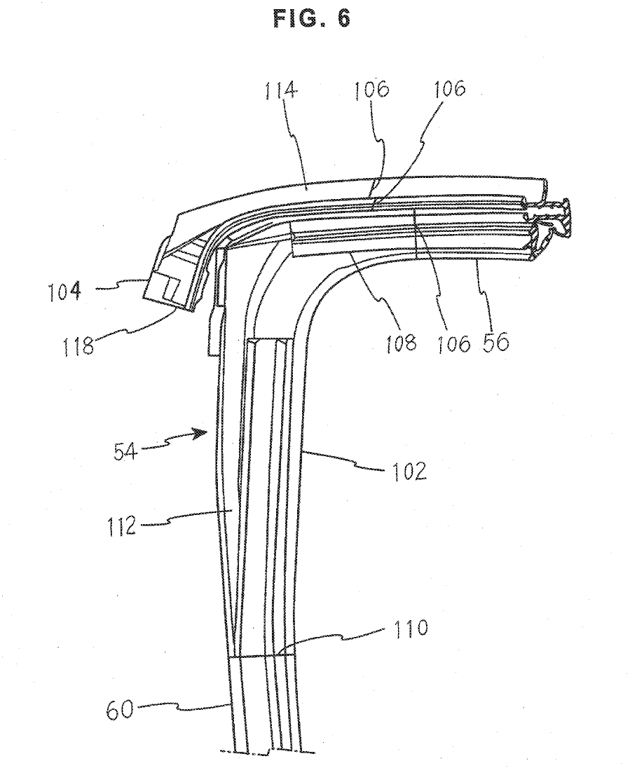

As shown in FIGS. 5 and 6, the corner connection section 102 is connected to the upper side portion 56 via corner upper connection faces 106 of an upper side connection part 108, and is connected to the rear vertical side portion 60 via corner lower connection faces 110 of a vertical side connection part 112.

The configuration of the corner connection section 102 gradually varies from that of the glass run section 66 of the upper side portion 56 and continues with that of the rear vertical side portion 60.

The corner upper connection face 106 connects the upper trim seal lip 92 of the upper side portion 56 of the glass run 54 to a corner trim seal lip 114 of the corner connection section 102. In addition, the corner upper connection face 106 connects the outer side wall 70 of the glass run section 66 and the bottom wall 90 of the trim section 68 of the upper side portion 56 to parts corresponding to an outer side wall of the glass run section 66 of the corner connection section 102 and a bottom wall of the trim section thereof. The upper trim seal lip 92 and the corner trim seal lip 114 are arranged such that the corner upper connection face 106 therebetween is inclined to a longitudinal direction of the upper side portion 56.

And the corner upper connection face 106 between the outer side wall 70 of the glass run section 66 and the bottom wall 90 of the trim section 68 of the upper side portion 56 and the parts corresponding to the outer side wall of the glass run section 66 and the bottom wall of the trim section of the corner connection section 102 is inclined to the longitudinal direction of the upper side portion 56.

As a result, the corner upper connection faces 106 have an increased area, whereby the connection strength thereof can be increased.

When the glass run 54 is attached to the door frame 18 or removed from a connecting mold, the glass run 54 is flexed. By thus inclining the connection faces 106, stresses applied to the corner upper connection faces 106, which are generated due to the flexure of the glass run 54, are divided in the peeling-off direction and the shearing direction so that peeling in the corner upper connection faces 106 can be restrained.

It is preferable that the corner upper connection faces 106 are inclined to a vertical face of the upper side portion 56 in a longitudinal direction thereof with an inclination angle of 15 through 45 degrees. In this case, the area of the corner upper connection faces 106 can be sufficiently increased so that the connection strength thereof can be increased, and the stresses applied to the corner upper connection faces 106 are suitably divided in the peeling-off direction and in the shearing direction, whereby peeling in the corner upper connection faces 106 can be restrained.

When the inclination angle of the corner upper connection faces 106 exceeds 45 degrees, the connection faces 106 excessively spread in the longitudinal direction thereof so that corner molded parts become excessively great, whereby production costs are increased and moldability is degraded.

When the inclination angle of the connection faces 106 is less than 15 degrees, the area of the corner upper connection faces 106 decreases so that the connection strength thereof becomes insufficient, and a component force divided in the peeling-off direction is not greatly decreased.

When the glass run 54 is attached to the door 12, the glass run 54 always flexes into a convex state upwardly of an automobile body so that stresses are always applied to each connection face 106. By inclining the connection faces 106, as described above, stresses applied to the connection faces 106 in the peeling-off direction can be decreased.

Since the glass run 54 always flexes into a convex state upwardly of the automobile body, a tip end of the upper trim seal lip 92 is positioned outwardly of the deformation thereof caused by the flexure of the glass run 54, whereby greatest stresses are applied thereto.

In addition, when the door 12 is opened while the glass run 54 always flexes into a convex state upwardly of the automobile body, such stresses can be decreased by the deformation of the upper trim seal lip 92 in a falling-down direction thereof, whereas when the door 2 is continuously closed, the upper trim seal lip 92 contacts the door opening portion 44 to limit the movement of the upper trim seal lip 92 so that such stresses cannot be decreased by the above-described deformation thereof in the falling-down direction. As a result, decrement of such stresses by virtue of the inclined faces can produce a great effect.

The upper trim seal lip 92 is formed to have rigidity greater than that of the corner trim seal lip 114, because when the corner portion is molded, the entire part thereof is required to be molded of the same material, and by decreasing the rigidity of the entire part of the corner connection section 102, the attachment of the corner portion to the door frame 18 is facilitated.

As described above, the upper trim seal lip 92 is formed to have rigidity greater than that of the corner trim seal lip 114 so that when stresses are applied to the corner upper connection faces 106, they may readily peel off. However, the corner upper connection faces 106 are inclined to the longitudinal direction of the upper side portion 56 so that the area of the corner upper connection faces 106 can increase to make the connection strength greater, and the applied stresses are divided in the peeling-off direction and the shearing direction, whereby the peeling of the corner upper connection faces 106 can be prevented. In addition, such advantage is also provided in the outer side wall 70 of the glass run section 66, and the bottom wall 90 of the trim section 68.

The connection face 106 between the upper trim seal lip 92 and the corner trim seal lip 114 is formed such that a root of the upper trim seal lip 92 is inclined to thrust on the side of the corner trim seal lip 114, as compared with a tip end of the seal lip 92 (namely, an upper end of the connection face 106 is inclined leftwardly in FIG. 5).

As a result, when the corner portion is molded, a longitudinal tip end of the upper side portion 56 of the glass run 54 is held with a mold. A transverse tip end of the upper trim seal lip 92 exhibiting low rigidity is held with the root thereof so that the upper trim seal lip 92 that is formed by extrusion can be connected without any deformation regardless of the flowing of a molding material.

It is preferable to form a low friction sliding layer in the seal lip 92 and the seal lip 114 on faces for contacting the door opening portion 44. In this case, when the door is opened and closed, generation of abnormal noises between the seal lips 92 and 114, and the door opening portion 44 are restrained. The low friction sliding layer for the seal lips 92 and 114 can be formed of the same material as that of the low friction sliding member formed on surfaces of the outer seal lip 76 and the inner seal lip 78. In addition, when, as shown in FIG. 4, a decoration molding 116 as a decoration member is attached to exterior surfaces of the bottom wall 90 of the trim section 68 and the outer side wall 70 of the glass run section 66, the appearance around the upper side of the door frame 18 can be improved. The decoration molding 116 is formed to extend to the corner upper connection faces 106 on the side of the upper side of the rear corner portion 64 along with the bottom wall 90 of the trim section 68.

Furthermore, as shown in FIG. 5 and FIG. 6, the corner engaging section 104 is formed on the side of a tip end of the upper side connection part 108 of the corner connection section 102 in the rear corner portion 64. An engaging part 118 for engagement with a tip end of the door frame 18 is formed in the vicinity of a tip end of the corner engaging section 104.

The corner lower connection faces 110 as connection faces between the vertical side connection part 112 of the corner connection section 102 and the rear vertical side portion 60 are formed in a linear shape.

Upon producing the glass run 54, a thermoplastic elastomer or a soft synthetic resin is used as the soft members, which are composed of a solid material or a sponge material. Examples of the thermoplastic elastomer include an olefin elastomer, and examples of the soft synthetic resin include a soft vinyl chloride. And an olefin synthetic resin such as polypropylene resin, polyethylene resin, etc. is used as the hard members of the glass run 54. While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A glass run adapted to be attached to a door frame of an automobile door for providing a seal between a door opening portion and the automobile door,
the glass run including an upper side portion formed by extrusion and adapted to be attached to an upper side of the door frame, a vertical side portion formed by extrusion and adapted to be attached to a vertical side of the door frame, and a corner portion formed by molding to connect the upper side portion and the vertical side portion to each other, and adapted to be attached to a corner of the door frame, wherein
the upper side portion includes a glass run section adapted to seal a door glass, and a trim section adapted to be attached to the door frame, the glass run section and the trim section are integrally formed with each other,
the glass run section includes an outer side wall, an inner side wall and a bottom wall with a generally U-shaped cross-section, an outer seal lip and an inner seal lip respectively extend from ends of the outer side wall and the inner side wall obliquely in an interior space of the glass run section with a generally U-shaped cross-section,
the trim section includes one side wall located on the side of the glass run section, the other side wall located on the side of an automobile body, and a bottom wall to define a generally U-shaped cross-section,
the corner portion includes a glass run section and a trim section, which are integrally formed with each other, and includes an upper side connection part adapted to be connected to the upper side portion, and a vertical side connection part adapted to be connected to the vertical side portion, and
connection faces between the upper side connection part of the corner portion and the upper side portion are inclined to a longitudinal direction of the upper side portion.

2. The glass run as claimed in claim 1, wherein the other side wall of the upper side portion, which is located on the side of an automobile body, has an upper trim seal lip contacting the door opening portion, the upper side connection part of the corner portion has a corner trim seal lip in the trim section thereof, which contacts the door opening portion, and the connection face between the upper trim seal lip and the corner trim seal lip is inclined to a longitudinal direction of the upper side portion of the glass run.

3. The glass run as claimed in claim 1 wherein the upper trim seal lip has rigidity greater than that of the corner trim seal lip.

4. The glass run as claimed in claim 1, wherein the connection face between the upper trim seal lip and the corner trim seal lip is inclined such that a root of the upper trim seal lip thrusts on the side of the corner trim seal lip, as compared with a tip end of the upper trim seal lip.

5. The glass run as claimed in claim 1, wherein a low friction sliding layer is formed on a face of the upper trim seal lip, which contacts the door opening portion.

6. The glass run as claimed in claim 1, wherein an upper connection face of the corner portion is arranged such that the connection face between the outer side wall of the glass run section and the bottom wall of the trim section of the upper side portion, and the outer side wall of the glass run section and the bottom wall of the trim section of the corner portion is inclined to a longitudinal direction of the upper side portion of the glass run.

7. The glass run as claimed in claim 1, wherein the connection faces between the upper side connection part and the upper side portion, and between the bottom wall of the trim section of the upper side portion, and the bottom wall of the trim section of the corner portion are respectively inclined with an inclination angle of 15 through 45 degrees.

8. The glass run as claimed in claim 1, wherein one side wall of the trim section, which is located on the side of the glass run section, and the bottom wall of the glass run section are formed integrally with each other.

9. The glass run as claimed in claim 1, wherein a decoration member is formed on exterior surfaces of the bottom wall of the trim section and the outer side wall of the glass run section continuously with the upper side portion.
